(19) United States
(12) Patent Application Publication
(10) Pub. No.: US 2005/0235137 A1
(43) Pub. Date: Oct. 20, 2005

(54) Rack equipment capacity on demand system and method

(76) Inventors: Andrew Harvey Barr, Roseville, CA (US); Kirk Michael Bresniker, Roseville, CA (US); Ricardo Espinoza-Ibarra, Lincoln, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/829,072

(22) Filed: Apr. 20, 2004

(51) Int. Cl. G06F 15/177

(52) U.S. Cl. 713/1

(57) ABSTRACT

A rack equipment capacity control system and method is presented. In one embodiment of the present invention, a capacity demand plan rack equipment control method is utilized to control operation of rack equipment. A rack equipment capacity alteration request is received. An analysis of the rack equipment capacity alteration request is performed. Performance of the rack equipment is changed in accordance with the analysis of the rack equipment capacity alteration request.

### FIELD OF THE INVENTION

The present invention relates to rack equipment operation management.

### BACKGROUND OF THE INVENTION

Electronic systems and circuits have made a significant contribution towards the advancement of modern society and are utilized in a number of applications to achieve advantageous results. Numerous electronic technologies such as digital computers, calculators, audio devices, video equipment, and telephone systems have facilitated increased productivity and reduced costs in analyzing and communicating data, ideas and trends in most areas of business, science, education and entertainment. Frequently, electronic systems designed to provide these advantageous results are realized through the leveraged utilization of centralized resources by distributed network nodes. The demand for centralized resource capacity by an end user application can vary significantly. However, centralized resources are usually assigned to an application on a fixed basis.

Centralizing certain resources within a distributed network typically provides desirable benefits. Clients interested in engaging a host to provide centralized resources and services typically have a desire to avoid providing the infrastructure, operation and maintenance directly themselves. Managing and maintaining different types of rack equipment and numerous applications in a typical large and complicated centralized networked host resource environment for a variety of different clients raises many challenging operational issues. Different clients often have different demands for resource capacity and the same clients even typically change their desire for resource capacity over time.

The manner in which centralized resources are operated is very important. Fixed preset rack equipment operating levels are often assigned upon a perceived generic implementation without consideration for variations in demand. The fixed assignments often have difficulty adequately addressing customers needs for deployment in a timely fashion and reduced time to market availability of the applications. Traditionally, additional new and/or upgraded equipment has to be purchased and installed to increase capacity or performance and traditionally limited attempts at manually adjusting the rack equipment usually require the operator to have extensive knowledge and understanding of unique features of each piece of equipment. The complexity and typical dynamic interaction of rack equipment tends to increase the probability of human error in making adjustments. In addition, there is usually very little notice of dynamic changes in capacity demand and manual reaction techniques usually have difficulty accommodating processing activity with urgent timing requirements. Delays involved in arranging the procurement, delivery and installation of the additional hardware is often to slow to respond to the fast paced changes in demand. In addition, the dynamic nature and high variability of typical capacity demand, especially in electronic business (e-business) applications, requires that the resources allocated to an application be easily adjustable to maintain service level agreements (SLAs).

### SUMMARY OF THE INVENTION

A rack equipment capacity control system and method is presented. In one embodiment of the present invention, a capacity demand plan rack equipment control method is utilized to control operation of rack equipment. A rack equipment capacity alteration request is received. An analysis of the rack equipment capacity alteration request is performed. Performance of the rack equipment is changed in accordance with the analysis of the rack equipment capacity alteration request.

### BRIEF DESCRIPTION OF THE DRAWINGS

The accompanying drawings, which are incorporated in and form a part of this specification, illustrate embodiments of the invention by way of example and not by way of limitation. The drawings referred to in this specification should be understood as not being drawn to scale except if specifically noted.

FIG. 1 is an illustration of a rack equipment capacity on demand system in accordance with one embodiment of the present invention.

FIG. 2 is an illustration of a capacity control component in accordance with one embodiment of the present invention.

FIG. 3 is a flow chart of a capacity control method in accordance with one embodiment of the present invention.

FIG. 4 is a block diagram of one embodiment of a computer system on which the present invention can be implemented.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it is understood the present invention may be practiced without these specific details. In other instances, some readily understood methods, procedures, components, and circuits have not been described in detail as not to unnecessarily obscure aspects of the current invention.

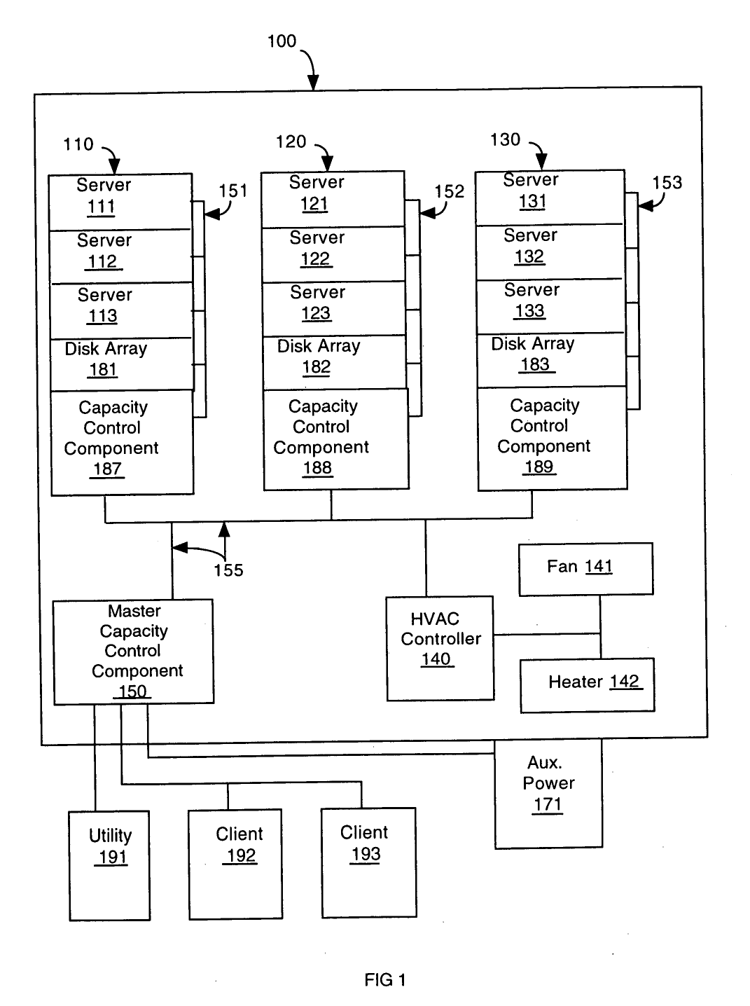

FIG. 1 is an illustration of rack equipment capacity on demand system 100, in accordance with one embodiment of the present invention. Rack equipment capacity on demand system 100 includes a plurality of racks 110, 120, and 130, master capacity control component 150, and heating, venting and air conditioning (HVAC) controller 140. Equipment racks 110, 120 and 130 comprise servers 111 through 133, disk arrays 181, 182 and 183, and capacity control components units 187, 188 and 189. Master capacity control component 150 is communicatively coupled to equipment in equipment racks 110, 120, and 130, and HVAC controller 140 through communication channel 155.

The components of rack equipment capacity on demand system 100 cooperatively operate to process information and change rack equipment operation settings in accordance with demand for resource capacity. It is appreciated that a variety of resources can be changed, including the number of servers, amount of memory, and/or the input/output resources that are assigned to an application. The plurality of servers 111 through 133 process information. Disk arrays 181, 182 and 183 store information for processing. Capacity control components 187, 188 and 189 control operational changes to equipment included in equipment racks 110, 120, and 130 based upon capacity demand. Master capacity control component 150 coordinates the changes “between” racks 110, 120 and 130 and equipment (e.g., HVAC controller 140) that support operations of multiple racks in accordance with capacity demand. Master capacity control component 150 also receives equipment rack capacity demand related information from power utility 191 and information processing clients 192 and 193. For example, master capacity control component 150 can receive notification of changes in capacity demands from processing clients 192 and 193. The capacity on demand can include a number or resources (e.g., servers, memory, etc.) that are added or removed from an application on real time work load and performance measurements

The communication links included in the rack equipment capacity on demand system 100 communicate information between components of system 100. Communication link 151 communicatively couples capacity control component 187 to other equipment (e.g., server 111, 112 and 113 and disk array 181) in rack 110. Communication link 152 communicatively couples capacity control component 188 to other equipment in rack 120. Communication link 153 communicatively couples capacity control component 189 to other equipment in rack 130. Communication link 155 communicatively couples master capacity control center 150, capacity control components 187, 188, and 189, and HVAC controller 140. There are a variety of configurations that are compatible with present invention communication links. A present invention communication link can be established by “injecting” (e.g., modulating) a signal on a power cord (e.g., AC or DC line cord), an RS-485 system, an Ethernet 10/100/1000 bT local area network (LAN), and/or wireless communications channels.

Capacity control components 187, 188, 189 and master capacity control component 150 change rack equipment and rack area support equipment operations in accordance with demand for capacity. In one embodiment, a capacity demand plan facilitates imposition of rack equipment operational changes based upon capacity demand guidelines. For example, the capacity demand plan can define operational settings of the rack equipment for various levels of capacity demand. The capacity control components analyze the capacity demand plan information in conjunction with equipment description information to formulate instructions to change operational settings of the equipment in racks 110, 120 and 130 and related support equipment. For example, the instruction can change operation settings and performance levels of the rack equipment. In one embodiment, the capacity control instructions maintain rack equipment operation within the power consumption and heat dissipation budget as well as capacity demand plan guidelines. The changes can facilitate maximization of tradeoffs between performance and price for additional resource capacity. The changes can also facilitate optimization of resource capacity allocation and power consumption/thermal dissipation. The capacity demand plan can be dynamically adjusted on the fly.

With reference still to FIG. 1, there are a variety of ways in which master capacity control component 150 and capacity control components 187, 188 and 189 change the operation settings of equipment included in rack equipment capacity on demand system 100. For example, capacity control components 187, 188 and 189 can direct changes in the frequency and operating voltage characteristics of equipment included in racks 110, 120 and 130 respectively. Capacity control components 187, 188 and 189 can also instruct equipment included in racks 110 through 130 respectively to turn on or off. Alternatively capacity control components 187, 188 and 189 can instruct execution components (e.g., parallel processors, pipelines, etc.) and/or portions of a memory component (e.g., a disk array, etc.) to turn on or off.

Master capacity control component 150 and capacity control components 187, 188 and 189 can also direct operational setting changes to various other detection and support components. Auxiliary power unit 171 provides auxiliary power in accordance with directions from master capacity control component 150 based upon capacity demand plan guidelines. HVAC controller 140 controls the heating, venting and cooling equipment associated with an area in which equipment racks 110, 120 and 130 are located. For example, HVAC controller 140 controls fan 141, heater 142 and an air conditioning unit (not shown) that vent, heat, and cool the area (e.g., a room) in which equipment racks 110, 120 and 130 are located. Master capacity control component 150 also directs operational setting changes in fan 141, heater 142 and the air conditioning unit (not shown) via HVAC controller 140.

Capacity control components (e.g., 187, 188, 189 and/or 150) can also comprise an interface for facilitating user interaction with rack equipment adjustments based upon power supply conditions. The interface allows operators or other equipment (e.g., remote resources coupled via a network) to manually and/or automatically participate in changes to rack equipment operational settings. The interface is a mechanism for communicating information to and from an operator or user. For example, the interface can enable operator intervention and provides a variety of power supply and performance related information in a cohesive, user friendly presentation.

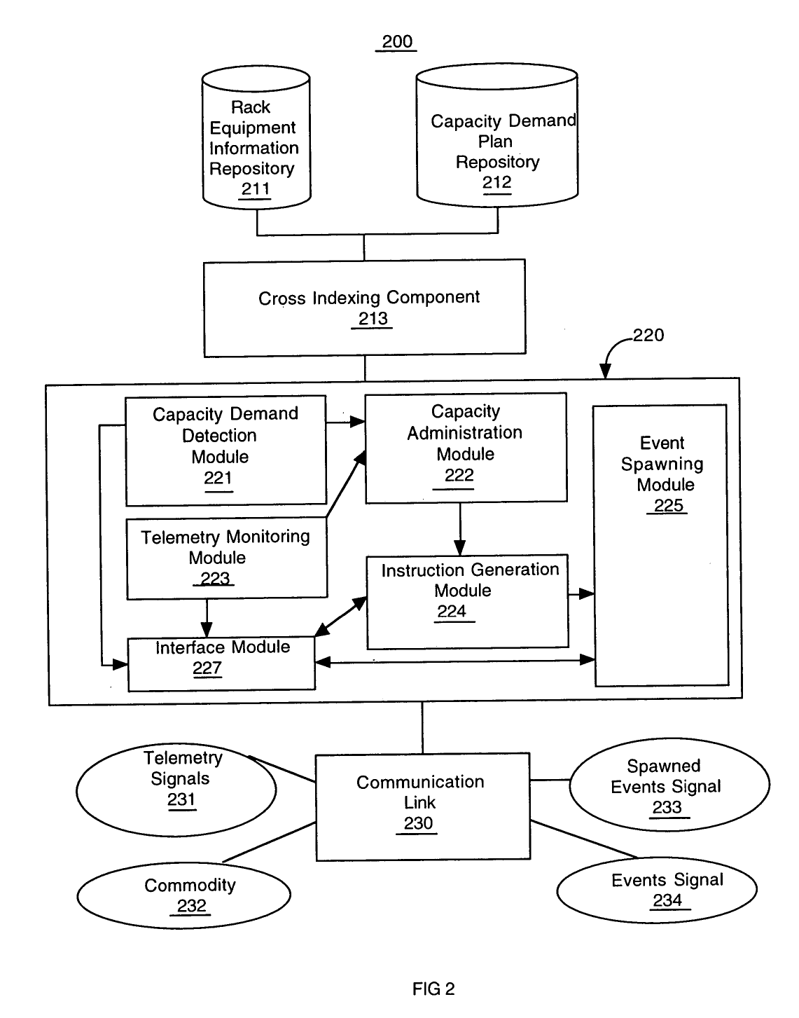

FIG. 2 is an illustration of capacity control component 200, one embodiment of a present invention capacity control component. Capacity control component 200 includes rack equipment information repository 211, capacity demand plan repository 212, cross indexing component 213, capacity demand plan processing component 220, and communication link component 230. The components of capacity control component 200 cooperatively operate to change operation settings of rack equipment based upon capacity demand plan policies. Rack equipment information repository 211 stores information about equipment included in the rack (e.g., rack equipment description information). Capacity demand plan repository 212 stores information on capacity demand plans (e.g., policy guidelines and plan objectives). Cross indexing component 213 correlates equipment information and capacity demand plan information. Capacity demand plan processing component 220 processes instructions for changing operation settings associated with capacity demand plan guidelines. Capacity control component 200 utilizes communication link 230 for external communications. For example, capacity control component 200 utilizes communication link 230 to forward and receive telemetry signals 231, commodity signals 232, spawned event signals 233 and trigger event signals 234.

In one embodiment, capacity demand plan processing component 220 includes capacity demand detection module 221, capacity administration module 222, telemetry collection module 223, instruction generation module 224, event spawning module 225 and interface module 227. Capacity demand detection module 221 detects indications of requests for capacity demand changes covered by a capacity demand plan.

Capacity administration module 222 administers examination of capacity demand changes. Telemetry monitoring module 223 monitors characteristics and activity information of equipment associated with said capacity demand plan. Instruction generation module 224 generates rack equipment performance adjustment commands for implementing the capacity demand plan instructions. Event spawning module 225 generates capacity demand plan trigger events. Interface module 227 performs interface operations.

Capacity demand detection module 221 can detect indications of a variety of requests for changes designated in a capacity demand plan. If capacity demand detection module 221 receives an indication of a capacity demand change request or triggering event, capacity demand plan detection module 221 sends an indication of the capacity demand request or trigger to capacity administration module 222 for examination and processing. For example, capacity demand detection module 221 can notice indications of capacity change requests and forwards notification of the request to capacity administration module 222. Capacity demand detection module 221 can receive the notice via communication link 230.

Capacity administration module 222 can analyze a variety of different capacity demand plan policy objectives in response to a request for a capacity change. The capacity administration module 222 can determine appropriate actions for implementing the capacity demand plan objectives. The capacity administration module 222 can determine if the occurrence of a capacity demand change indicates a modification to the operating settings of rack equipment (e.g., return to its prior condition and/or a condition indicated in a capacity demand plan policy objective). The capacity administration module 222 can also determine if actions or corrections to operational settings are limited by other policy constraints. For example, capacity administration module 222 can also determine if a power consumption and heat dissipation budget limit capacity demand plan objective actions or if any of the policies contradict or limit each other. The capacity administration module 222 provides an indication of the action (e.g., a temperature change) to instruction generation module 224.

Telemetry monitoring module 223 can be utilized to monitor telemetry information associated with various different changes in equipment rack operational settings. Telemetry monitoring module 223 is readily adaptable for utilization with a variety of different rack equipment. Telemetry monitoring module 223 can also direct collection or retrieval of information for confirming operational settings and performance adjustment commands are complied with. Telemetry module 223 can also direct retrieval of rack equipment description information (e.g., rack equipment operation settings and performance levels) and support equipment (e.g., HVAC units).

Instruction generation module 224 is capable of creating a variety of different instructions in response to notifications received from capacity administration module 222. Instruction generation module 224 can extract instruction protocol and syntax requirements from rack equipment description information (e.g., included in a rack equipment information repository). The instructions can direct a change in rack equipment and/or support equipment operating settings. For example, the instructions can direct a change in a temperature setting of HVAC support equipment and/or heat dissipation level for the rack equipment. The instructions can include a command or direction to change the operating frequency, change the voltage of supply power or turn on/off rack equipment and/or support equipment (e.g., fan 141, heater 142, auxiliary power unit 171, etc.). The operation adjustment instructions can be forwarded to rack equipment and associated support equipment. For example, instruction creation module 224 can forward operation adjustment instructions to change the operation settings of the rack equipment.

Event spawning module 225 spawns capacity demand plan trigger events. Event spawning module 225 can spawn a capacity demand plan triggering event that causes a capacity control component to interface with other capacity control components. Alternatively, event spawning module 225 can spawn a capacity demand plan triggering event directly for rack equipment under the control of other capacity control components, clients, and/or external support operations (e.g., a power utility). For example, master capacity control component 150 can receive indications of a power supply fluctuation from utility 191 and spawn a triggering event indication to capacity control component 187, 188 and/or 189. Conversely, capacity control components 187, 188 and 189 can spawn a triggering event requesting more power that causes master capacity control component 150 to direct auxiliary power 171 to increase or decrease the power supply in accordance with a predetermined capacity demand plan policy.

In one embodiment of the present invention, a capacity control component (e.g., 187) is included in an intelligent power distribution unit (IPDU). The IPDU can be utilized to aggregate multiple power line cords from rack equipment into a smaller number of power line cords at a rack level. In one exemplary implementation in which power cords are used as a present invention communication link, the presence of each piece of rack equipment can be detected as the rack equipment is communicatively coupled to the IDPU. In addition, information associated with the piece of rack equipment (e.g., power and thermal performance operating points, information indicating the type of rack equipment, characteristics of the rack equipment, etc.) can be automatically communicated to the IPDU. Even if a piece of rack equipment does not have an available relevant descriptive information store itself, the IPDU can sense current draw and account for unregulated use in equipment rack management policy decisions.

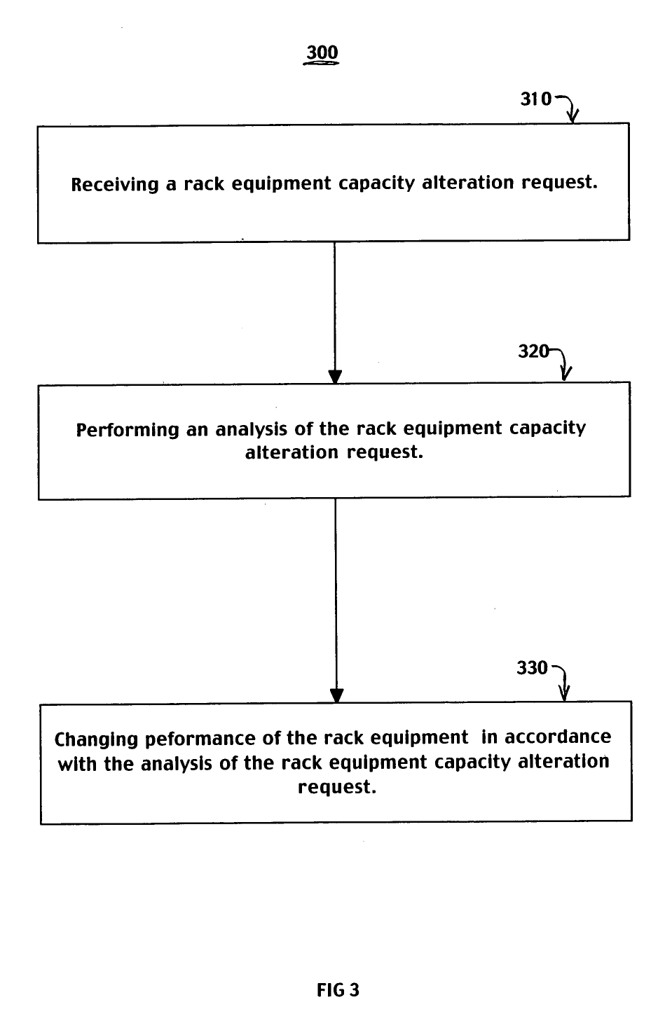

FIG. 3 is a flow chart of capacity control method 300 in accordance with one embodiment of the present invention. Capacity control method 300 establishes a communication and control protocol for automatic control of rack equipment operating conditions based upon a capacity demand plan. The communication and control protocol also facilitates manipulation of rack equipment operation and performance in accordance with a rack equipment capacity demand plan or policies. Capacity control method 300 also provides an interface for presenting information in a convenient manner to a user.

In step 310, a rack equipment capacity alteration request is received. The rack equipment alteration request can be directed to a number of different rack equipment resources. For example, the request can be directed to assigning additional servers, memory, and or input/output resources to an application. Alternatively, the request can be directed to removing resources from assignment to an application. The request can also be directed to changes in rack equipment operational settings (e.g., turn rack equipment on or off, increase or decrease speed and/or power, etc.). In one exemplary implementation, information indicating a capacity demand alteration trigger event (e.g., capacity demand change) is received.

In step 320, the rack equipment capacity alteration request is analyzed. In one embodiment of the present invention, the analysis includes analyzing the request with respect to a capacity demand plan for operating the rack equipment. The capacity demand plan can include a variety of operational setting guidelines that are tied to a capacity on demand business model. For example, a capacity demand plan includes instructions to turn on or off rack equipment if capacity demand increases or decreases respectively beyond predetermined thresholds. The capacity demand plan can include instructions to increase or reduce a voltage and/or a frequency of the rack equipment when the demand for resource capacity increases or decreases respectively. It is appreciated that a power price plan is flexibly adaptable to a variety of implementations. For example, a power price plan can include instructions to make similar changes (e.g., turn on/off, change voltage/frequency, etc.) to the operation of support equipment (e.g., HVAC controller 140, auxiliary power unit 171, etc.) to support changes in demand for resource capacity.

The capacity demand plan also includes business model guidelines corresponding to agreements for adjusting rack equipment. In one exemplary implementation, if the capacity demand for a particular resource increases the capacity demand plan also includes directions for a corresponding increase in price paid for utilization of the resource. For example, if a client demand for server capacity increases the capacity demand plan also includes a corresponding increase in the price paid be the client. The analysis of step 320 includes verifying that a payment associated with the rack equipment alteration request has been made.

In step 330, operation of the rack equipment is altered in accordance with the analysis of the rack equipment capacity alteration request. For example, if the requisite fees are paid instructions for controlling the rack equipment are generated and communicated to the rack equipment. The control instructions are based upon the capacity demand plan and are sent to the rack equipment and/or support equipment. For example, the change can include turning on/off rack equipment associated with data processing. In one implementation, the instruction corresponds to an operation setting action set forth in a capacity demand plan for increases associated with a particular fee. For example, the command can include determining an appropriate adjustment setting for rack equipment (e.g., heat dissipation settings) and/or support equipment (e.g., auxiliary power supply setting) in response to a particular capacity demand change. The instruction can also be tailored to possible actions available for a particular piece of rack equipment.

In one embodiment, implementation of a rack equipment change is checked. For example, equipment setting changes are checked for compliance with the capacity demand plan guidelines. The equipment can include rack equipment and support equipment. The equipment setting changes are directed to bring operation of the rack equipment within guidelines set forth in a capacity demand plan. In one exemplary implementation, instructions for changing the equipment settings are forwarded to the rack equipment and the response of the equipment is checked. The setting changes can change the power consumption and thermal load of the rack equipment. For example, the changes can result in an increase or decrease in the heat dissipated by the rack.

In step 340, the capacity demand plan is automatically adjusted interactively. In one embodiment the capacity demand plan is adjusted via a capacity demand plan adjustment interface. The interface activities also include presenting information in a convenient and user friendly manner. For example, capacity demand plan information, corresponding rack equipment description information and telemetry information (e.g., operating level settings) can be displayed. Similar information associated with rack support equipment (e.g., HVAC equipment, auxiliary power, etc.) can also be presented. The interface activities also include automatically adjusting the capacity demand plan interactively.

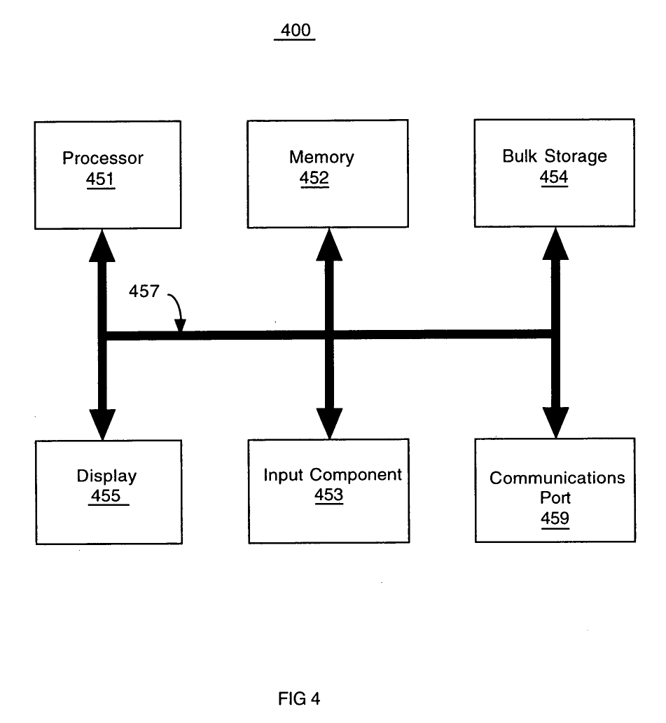

FIG. 4 is a block diagram of computer system 400, one embodiment of a computer system on which the present invention can be implemented. For example, computer system 400 can be utilized to implement capacity demand plan processing component 220 or capacity control method 300. Computer system 400 includes communication bus 457, processor 451, memory 452, input component 453, bulk storage component 454 (e.g., a disk drive), network communication port 459 and display module 455. Communication bus 457 is coupled to central processor 451, memory 452, input component 453, bulk storage component 454, network communication port 459 and display module 455.

The components of computer system 400 cooperatively function to provide a variety of functions, including directing changes in rack equipment operational settings in accordance with a capacity demand plan of the present invention. Communication bus 457 communicates information within computer system 400. Processor 451 processes information and instructions, including instructions and information for changing rack equipment operation and performance (e.g., processor 451 processes capacity demand detection module 221 instructions, capacity administration module 222 instructions, telemetry monitoring module 223 instructions, instruction generation module 224 instructions, etc.). Memory 452 stores information and instructions, including instructions for implementing a rack equipment capacity demand plan. Bulk storage component 454 also provides storage of information (e.g., rack equipment description information, policy information, etc.). One embodiment of a present interface can be implemented by input component 453, display module 455 and network communications port 459. Input component 453 facilitates communication of information (e.g., operator policy initiated changes, operator entered rack equipment description information, operator intervention in rack equipment operation changes, etc.) to computer system 400. Display module 455 displays information to a user (e.g., a graphical user interface conveying rack equipment operation settings and performance levels, rack equipment description information, capacity demand plan policy information, correlation between the information, etc.). Network communication port 459 provides a communication port for communicatively coupling with a network (e.g., for communicating capacity demand plan related information with a client, a utility, a remote operator and/or control center, etc.).

Thus, a present invention rack equipment capacity demand plan system and method facilitates convenient and efficient operation of rack equipment based upon a capacity demand plan. The rack equipment capacity demand plan permits automated implementation of rack equipment capacity demand policies and associated economic management objectives. For example, the present inventions can assist centralized computer facilities to cope with changes in demand for rack equipment resources. Automatic direction of equipment operation setting and performance level adjustments is provided to meet the rack equipment capacity demand plan objectives. Equipment description information, policy information and rack equipment operation modification commands are automatically communicated via communication links implementing a rack equipment management protocol. The communication links are flexibly adaptive to a variety of implementations and can be implemented on an available communication medium (e.g., power line cords). The present invention also provides a convenient and efficient interface that can correlate diverse rack equipment management and capacity demand information in a unified manner.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various modifications as are suited to the particular use contemplated. It is intended that the scope of the invention be defined by the claims appended hereto and their equivalents.

1. A method of dynamically changing rack capacity on demand, said method comprising:
receiving a rack equipment capacity alteration request;
performing an analysis of said rack equipment capacity alteration request; and
changing performance of rack equipment in accordance with said analysis of said rack equipment capacity alteration request.

2. The method of claim 1, wherein changing said performance of said rack equipment includes said altering said rack equipment performance settings.

3. The method of claim 1, wherein changing said performance of said rack equipment includes changing performance capacity by said rack equipment in accordance with said capacity demand plan.

4. The method of claim 3, wherein said capacity demand plan indicates an increase in a voltage and a frequency of said rack equipment when a demand for capacity increases.

5. The method of claim 3, wherein said change in said performance of said rack equipment corresponds to a change in a clients business requirements.

6. The method of claim 1, wherein said controlling said operation comprises automatically changing said performance interactively.

7. The method of claim 1, further comprising verifying a payment associated with said rack equipment capacity alteration request is made.

8. A rack equipment capacity on demand system comprising:
rack equipment for processing data;
a capacity demand plan component for controlling operational changes to said rack equipment based on a capacity demand plan; and
a communications bus for coupling said equipment and said capacity control component, wherein said communications bus is utilized for communicating information between said capacity control component and said rack equipment.

9. The rack equipment capacity on demand system of claim 8, wherein said capacity demand plan component controls the amount of rack equipment resources assigned to an application.

10. The rack equipment capacity on demand system of claim 8, wherein said capacity demand plan component switches on and off said rack equipment in accordance with said capacity demand plan.

11. The rack equipment capacity on demand system of claim 8, further comprising a master management control center for coordinating control of rack equipment among a plurality of racks.

12. The rack equipment capacity on demand system of claim 8, wherein said capacity demand plan policy is dynamically adjustable on the fly.

13. The rack equipment capacity on demand system of claim 8, wherein said capacity demand plan policy is structured in accordance with business needs of a client.

14. The rack equipment capacity on demand system of claim 8, further comprising:
a memory for storing equipment information and capacity demand plan information; and
a cross indexing component for cross indexing said equipment information and said capacity demand plan policy information.

15. A computer-useable storage medium comprising computer-readable program code embodied therein for causing a computer system to implement a power pricing performance instructions comprising:
a capacity demand detection module for detecting indications of requests for capacity demand changes covered by a capacity demand plan;
a capacity demand administration module for administering examination of capacity demand changes; and
an instruction generation module for generating rack equipment performance adjustment commands to implement said capacity demand plan instructions.

16. The computer storage medium of claim 15, further comprising a telemetry monitoring module for monitoring characteristics and activity of rack equipment associated with said adjustments commands.

17. The computer storage medium of claim 15, further comprising a event spawning module for generating power pricing events.

18. The computer storage medium of claim 15, wherein said instruction generation module comprises functionality for generating a command to postpone processing.

19. The computer storage medium of claim 15, wherein said capacity demand plan information is an agreement between a host and a client and is structured in manner to accommodate business activities of said client.

20. The computer storage medium of claim 15, wherein said telemetry monitoring module also confirms said performance adjustments commands are complied with.
